(19) United States
(12) Patent Application Publication
(10) Pub. No.: US 2007/0124378 A1
(43) Pub. Date: May 31, 2007

(54) Method and system for indicate and post processing in a flow through data architecture

(76) Inventor: Uri Elzur, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/549,444

(22) Filed: Oct. 13, 2006

Related U.S. Application Data
(60) Provisional application No. 60/726,914, filed on Oct. 14, 2005.

(51) Int. Cl. G06F 15/16

(52) U.S. Cl. 709/204

(57) ABSTRACT

Aspects of a method and system for indicate and post processing in a flow through data architecture are presented. Aspects of the system may include a network interface controller that enables storage with zero copy of at least a portion of a plurality of received messages based on policies that may be enforced by the network interface controller and based on ULP provided buffers. The network interface controller may enable generation of a signal to a host processor that processes some of the stored plurality of received messages based on the policies that may be enforced by the network interface controller.

### CROSS-REFERENCE TO RELATED APPLICATIONS/INCORPORATION BY REFERENCE

This application makes reference to, claims priority to, and claims the benefit of U.S. Provisional Application Ser. No. 60/726,914 filed Oct. 14, 2005.

The above referenced application is hereby incorporated herein by reference in its entirety.

### FIELD OF THE INVENTION

Certain embodiments of the invention relate to data communications. More specifically, certain embodiments of the invention relate to a method and system for indicate and post processing in a flow through data architecture.

### BACKGROUND OF THE INVENTION

In conventional computing, a single computer system is often utilized to perform operations on data. The operations may be performed by a single processor, or central processing unit (CPU) within the computer. The operations performed on the data may include numerical calculations, or file server access, for example. The CPU may perform the operations under the control of a stored program containing executable code. The code may include a series of instructions that may be executed by the CPU that cause the computer to perform the operations on the data. The capability of a computer in performing these operations may variously be measured in units of millions of instructions per second (MIPS), or millions of operations per second (MOPS).

Historically, increases in computer performance have depended on improvements in integrated circuit technology, and were often governed by the principles of “Moore's law”. Moore's law postulates that the speed of integrated circuit devices may increase at a predictable, and approximately constant, rate over time. However, technology limitations may begin to limit the ability to maintain predictable speed improvements in integrated circuit devices.

Another approach to increasing computer performance implements changes in computer architecture. For example, the introduction of parallel processing may be utilized. In a parallel processing approach, computer systems may utilize a plurality of CPUs within a computer system that may work together to perform operations on data. Parallel processing computers may offer computing performance that may increase as the number of parallel processing CPUs in increased. The size and expense of parallel processing computer systems result in special purpose computer systems. This may limit the range of applications in which the systems may be feasibly or economically utilized.

An alternative to large parallel processing computer systems is cluster computing. In cluster computing, a plurality of smaller computer, connected via a network, may work together to perform operations on data. Cluster computing systems may be implemented, for example, utilizing relatively low cost, general purpose, personal computers or servers. In a cluster computing environment, computers in the cluster may exchange information across a network similar to the way that parallel processing CPUs exchange information across an internal bus. Cluster computing systems may also scale to include networked supercomputers. The collaborative arrangement of computers working cooperatively to perform operations on data may be referred to as high performance computing (HPC).

Cluster computing offers the promise of systems with greatly increased computing performance relative to single processor computers by enabling a plurality of processors distributed across a network to work cooperatively to solve computationally intensive computing problems. One aspect of cooperation between computers may include the sharing of information among computers. Remote direct memory access (RDMA) is a method that enables a processor in a local computer to gain direct access to memory in a remote computer across the network. RDMA may provide improved information transfer performance when compared to traditional communications protocols. RDMA has been deployed in local area network (LAN) environments some of which have been standardized and others which are proprietary. RDMA, when utilized in wide area network (WAN) and Internet environments, is referred to as RDMA over TCP, RDMA over IP, or RDMA over TCP/IP.

One of the problems attendant with some distributed cluster computing systems is that the frequent communications between distributed processors may impose a processing burden on the processors. The increase in processor utilization associated with the increasing processing burden may reduce the efficiency of the computing cluster for solving computing problems. The performance of cluster computing systems may be further compromised by bandwidth bottlenecks that may occur when sending and/or receiving data from processors distributed across the network.

In some conventional systems, e.g. a file server is engaged in providing file services to a set of clients. The clients would send a command for instance to write a file. The server may need to parse the request, allocate a buffer and place the data in memory. The network interface controller (NIC) hardware (HW) involved in reception of the request is not aware of the content of the request. Methods like Indicate and Post are used by NIC HW and software to provide file serving software (SW) with a command (for example, Indicate). In addition, a buffer post may be provided at which data from the file serving SW response is to be copied. There are several potential performance limitations in the scheme, a host processor may receive an interrupt service routine (ISR) priority level interrupt when a message is received via a network at a destination computer system, regardless of the size, as measured in bytes for example, of the received message. This causes a burden measured at frame per second rather than file service requests per second, which can be a smaller number. However, a high interrupt rate coupled with latency associated with schemes like Indicate and Post may cause the data transfer performance of these conventional systems to not scale as data transfer rates increase for various communications media. For example, in a 10 Gb Ethernet LAN the wire speed data transfer performance of the communications medium may exceed the data transfer performance of the destination computer system. In this regard, the destination computer system may become a bottleneck, limiting the data transfer rate for data communicated between an originating computer system and the destination computer system. This bottleneck may become particularly apparent, due to inefficiencies in some conventional systems, when the destination computer system receives large numbers of interrupts resulting from the receipt of correspondingly large numbers of relatively small sized messages, at increasingly high rates, via the network. In addition, latency-laden techniques like Indicate and post may impose additional overhead and data copy in host side software that may strain the memory subsystem and/or prevent the system from providing high throughput on par with the network speed.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for indicate and post processing in a flow through data architecture, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary file server with multiple clients, in connection with an embodiment of the invention.

FIG. 2A illustrates exemplary configuration of a network interface controller for indicate and post processing in a flow through data architecture, in accordance with an embodiment of the invention.

FIG. 2B illustrates an exemplary message exchange in a system for indicate and post processing in a flow through data architecture, in accordance with an embodiment of the invention.

FIG. 3 is a flowchart illustrating exemplary steps for indicate and post processing in a flow through data architecture, in accordance with an embodiment of the invention.

### DETAILED DESCRIPTION OF THE INVENTION

Certain embodiments of the invention relate to a method and system for upper layer protocol (ULP) processing. The ULP may have a protocol data unit (PDU) riding on top of the transport layer protocol e.g. TCP. The receiver has to process the transport, then parse the ULP message, allocate a buffer for the specific request conveyed by the ULP and then place the data in the buffer. More specifically, first the receiver is to parse the boundaries of the ULP message, locate the header, parse it, follow the instructions embedded in it, in order to process and potentially place the provided data if present. As lower layers of HW or software are not necessarily adapted to process the ULP, methods have been developed to allow processing of the ULP control and data potentially carried in tandem on the network. One such method is Indicate and Post. In this case, the lower layer provides to the ULP an arbitrary number of bytes that may be adjusted to include at least one ULP header. The ULP processes the header, identifies the required action and decides how to treat the rest of the message. For a write request, for example, the header may include the ULP operation code (opcode) for the desired operation along with an identifier that may relate the request to an ongoing task or transaction or to a specific buffer. Alternatively the ULP may use such an identifier to allocate a buffer or may use other criteria, e.g. identity of request originator, type of request, availability of buffer, security considerations, quota per client or per application or per specific request or request type, to decide when, and what buffer to allocate. A server may be also serving a large number of clients while trying to limit the number of buffers outstanding. When a buffer is allocated, it will provide information to the lower layer such as where the lower layer may place the data (normally subsequent in the message received from the network) into the buffer pointed to by the ULP. This process involves multiple steps with specifically at least two interactions per I/O between lower layers and ULP.

The time for the ULP to react to the Indicate is measured from the Interrupt to the Indicate event with the Post response from the ULP. It involves interrupt moderation delay, operating system (OS) delays (running the interrupt service routine, scheduling the DPC and running it, potentially running protocol stack, calling the ULP running it, and posting a buffer back to the lower layers. If the data is still flowing into the machine, then the rest of the PDU may be placed into the ULP allocated buffer (i.e. “zero copy”) saving significant overhead, resources and latency. However, if the buffer posting has been received after the data has been received, then an additional copy will be required from the temporary buffer used to store the data until a buffer is posted, to the ULP allocated buffer. With slow networks, the response time from the Indicate event to ULP buffer posting may have been short enough to allow more cases with zero copy. With increased network speed and with system speeds (CPU and memory) as well as OS real time responsiveness not keeping pace, the chances of getting the data to land in the ULP allocated buffer are becoming smaller. Analysis of a 10 Gigabit Ethernet operation may show that this scheme may result in a diminished opportunity for zero copy during data copy operations.

In order to improve the probability of zero copy the latency associated with a full round trip from hardware to ULP and back needs to be addressed. Various embodiments of the invention comprise a method by which a host processor may enable a network interface controller to pre-screen messages, comprising data and/or instructions (headers), which are received from other host devices to which the host processor may be communicatively coupled via a network. In this regard, the host processor may provide the network interface controller with policy state information. The policy state information may instruct the network interface controller on buffer allocation procedures and policies to be performed upon receipt of messages via the network. Based on the buffer allocation procedures, the network interface controller may transfer at least a portion of received messages to buffer allocated by the ULP, therefore saving the associated data copy and system overhead. The policy may be similar to the policy or heuristics or algorithm used by the ULP to allocate buffer and may vary from one ULP to another.

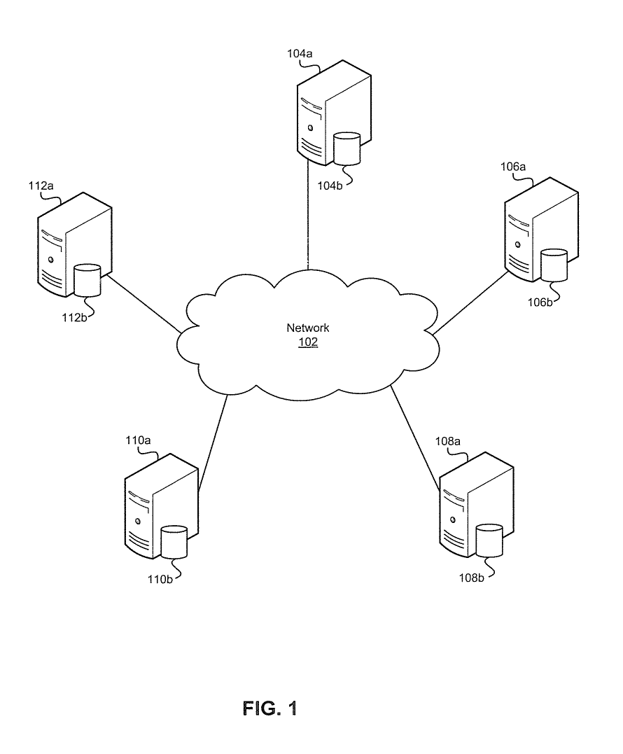

FIG. 1 illustrates an exemplary file server with multiple clients, in connection with an embodiment of the invention. Referring to FIG. 1, there is shown a network 102, a plurality of computer systems 104a, 106a, 108a, 110a, and 112a, and a corresponding plurality of ULP such as file server applications 104b, 106b, 108b, 110b, and 112b. The computer systems 104a, 106a, 108a, 110a, and 112a may be coupled to the network 102. One or more of the computer systems 104a, 106a, 108a, 110a, and 112a comprise a server ULP providing services to the corresponding applications 104b, 106b, 108b, 110b, and 112b, respectively, for example. In general, a plurality of software processes, for example a file serving application, may be executing concurrently at a computer system.

In a distributed processing environment, such as in distributed file system processing, for example, a file server application, for example 104b, may communicate with one or more client applications, for example 106b, 108b, 110b, or 112b, via a network, for example, 102. The operation of the file server application 104b may be coupled to the operation of one or more of the clients 106b, 108b, 110b, or 112b.

In some conventional cluster environments, a cluster application may communicate with a peer cluster application via a network by establishing a network connection between the cluster application and the peer application, exchanging information via the network connection, and subsequently terminating the connection at the end of the information exchange. An exemplary communications protocol that may be utilized to establish a network connection is the Transmission Control Protocol (TCP). An exemplary protocol that may be utilized to route information transported in a network connection across a network is the Internet Protocol (IP). An exemplary medium for transporting and routing information across a network is Ethernet, a standardized version of which is defined by Institute of Electrical and Electronics Engineers (IEEE) resolution 802.3.

For example, file server application 104b may establish a TCP connection to file server application 110b. The file server application 104b may initiate establishment of the TCP connection by sending a connection establishment request to the peer file server application 110b. The connection establishment request may be routed from the computer system 104a, across the network 102, to the computer system 110a, via IP. The peer file server application 110b may respond to the received connection establishment request by sending a connection establishment confirmation to the file server application 104b. The connection establishment confirmation may be routed from the computer system 110a, across the network 102, to the computer system 104a, via IP. The established connection may be identified based on a connection identifier.

After establishing the TCP connection, the file server application 104b may send a message to the file server application 110b via the established TCP connection. The message may comprise a write request, and/or at least a portion of data, which are the subject of the write request. The write request may comprise a request from the file client application 104b to the file server application 110b that the data, which are the subject of the write request, be stored in memory at the computer system 110a, allocated by the file server ULP.

The data may not be immediately written to memory in the computer system 110a. Since the file server application 110b may communicate with a large number of peer applications, such as file server application 104b, the file server application 110b may require large quantities of memory and/or processing resources at the computer system 110a to accommodate messages that may be received from any of a large number of peer applications, which may arrive at unpredictable time instants. Given that there may be limited host processing and/or memory resources, applications may be required to limit resource allocation. Furthermore, to provide a secure environment, some peer applications may not be fully or partially trusted, therefore, the file server application 110b may limit, as a matter of policy, access to memory and/or processing resources at the computer system 110a for peer applications which are not fully trusted.

One method utilized for limiting resource allocation required by an application, such as the file server application 110b, at a computer system, such as the computer system 110a, is referred to as “indicate and post” (I&P). When utilizing the I&P method for the exemplary message exchange between the file server applications 104b and 110b, the message may be received, from the network 102, at a network interface controller within the computer system 110a. The network interface controller may comprise processing and/or memory resources that may be utilized to store the message within the network interface controller. The processing and/or memory resources within the network interface controller may be physically and/or logically separate from main, or “host” processing and/or memory resources within the computer system 110a.

After storing the received message or a portion of the ULP message, the processor within the network interface controller may process the message by sending at least a portion of the message to the host processor. The message may be communicated between the network interface controller processor and the host processor via a bus architecture, internal to the computer system 110a, to which both processors may be communicatively coupled. The portion of the message communicated to the host processor may comprise information that identifies the computer system and/or application from which the message originated, for example computer system 104a, and file server application 104b. The portion of the message may indicate an action associated with the message, for example a write request, and a specific reference number or transaction number managed by the ULP or at least known to the ULP, the message may indicate a quantity of data associated with the action, for example an amount of data, which is the subject of the write request.

From a software processing perspective, the network interface controller processor may indicate the presence of message comprising this portion of information by asserting the interrupt signal followed by a message of an arbitrary size, which may be adjusted per ULP. The interrupt signal or message may be associated with a high priority level, for example an interrupt service routine (ISR) priority level, which may prompt the host processor to interrupt a currently executing task to inspect the interrupt message. Upon inspecting the interrupt message, the host processor may assign a priority level for performing subsequent processing on the contents of the interrupt message, referred to as a deferred procedure call (DPC) in some operating systems. The assigned priority level may be a lower priority level than associated with initial processing of the interrupt signal or message. If further processing is to occur at a later time instant, the initiation of subsequent processing at a later time instant may be via a deferred procedure call (DPC).

At the later time instant, the host processor may communicate at least a portion of the contents of the interrupt message to the file server application 110b. The file server application 110b may determine that at least a portion of the write request message, originated from the file server application 104b, and associated data may be stored in memory at the computer system 110a. The write request message and associated data may subsequently be stored utilizing host processor memory resources. The file server application 110b may send an acknowledgement indicating completion of the write request to the file server application 104b via the established TCP connection. The file server application 104b may terminate the established TCP connection by sending a connection terminate indication to the file server application 110b.

The process by which a message is received via a network, stored in the NIC, and subsequently transferred to host memory may be referred to as a store and forward (S&F) data architecture. In the example above, when the data to be written in communicated from the file server application 104b to the file server application 110b via a plurality of messages, the first message may be transferred to between the originating application in the computer system 104a to the host memory in the computer system 110a creating an Indication event. During the time before the indication (along with the header information) is provided to the ULP 110b, subsequent packets constituting the remaining parts of the message may stored by the NIC. When the ULP allocates a buffer the NIC may copy the remaining portion of the message directly (i.e. zero copy) to the allocated ULP buffer. The buffer employed by the NIC compensates for the latency and allow the data to traverse the bus and the memory subsystem once. However the NIC dedicated memory or buffer has to scale with the network speed, making its cost and real estate requirement impractical in many cost conscious implementations. In such case, even when the data transfer capacity increases for the underlying network transport medium, for example 10 gigabit (Gb) Ethernet, the I&P mechanism may still work with increased NIC buffer size compensating for the larger amount of data accumulated while the ULP is trying to allocate a buffer and signal it to the NIC.

Additional sources of latency may be imposed due to file sharing protocols, which may enable applications copy data from files stored in one computer system to files stored in another computer system. The example above may be utilized within the context of file sharing protocols. Exemplary file sharing protocols may comprise the network file system (NFS), the NetWare core protocol (NCP), the Apple filing protocol (AFP), the common Internet file system (CIFS), server message block (SMB), and Samba.

For a flow through NIC architecture, a decision about where to place the data may be made when the packet is received. With the ULP buffer unknown, the NIC may use a temporary buffer in the host memory, missing an opportunity for a zero copy operation. As network data transfer rates increase, the relatively fixed latency may result in at least a portion of the message being temporarily buffered followed by an extra copy.

Various embodiments of the invention may comprise a method and system by which an application, for example the file server application 110b,may store policy state information along with a list of buffers within the network interface controller within the computer system 110a. The policy state information may enable the network interface controller to inspect a message received via the network 102, and to determine, based on the policy state information, how to process the received message and what buffer to allocate for it. For example, the network interface controller processor may inspect the received message to determine the computer system and/or the guest operating system GOS (in case of virtualization), and/or application from which the message originated, the action associated with the message, the reference task or operation number, and/or the quantity of data associated with the message. Based on the stored policy state information, the network interface controller may determine whether, for a received message comprising a write request for example, the associated data will use one of the potential buffers provided by the ULP or protocol stack. If a buffer is allocated by the NIC acting on behalf of the ULP, the remainder of the message may be transferred to ULP allocated buffer in host memory. In various embodiments of the invention, this transfer may be achieved without requiring the set of interrupts, and corresponding latencies, associated with the S&F data architecture. This may be referred to as an l&P solution for a “flow through” architecture.

In various embodiments of the invention, policies and actual resources may be configured at the network interface controller. The policies may be utilized to allocate memory resources within the buffers allocated by the ULP on the host memory. The policies may enable memory resources to be allocated based on a connection identifier associated with a TCP connection, such that a limit on the quantity of memory resources may vary based on the connection identifier. Similarly, the policies may enable memory resources to be allocated based on a process identifier. A process identifier may identify an application, a process or a thread and/or application, process or thread within a GOS, which is communicating data to be stored. The policies may enable memory resources to be allocated based on message request type, for example a CIFS, or NFS request. However for each of the protocols or ULPs supported, the NIC has to be able to locate and parse the ULP headers to enable recognition of the command or header and the data portion as required for a high speed operation of the scheme. This is done in a generic way for RDMA (for example) based applications but in the general case, the NIC may be adapted to process the ULP message format and identify the relevant commands as well as commands that can not be independently processed. To minimize the burden on the NIC and increase the effectiveness of the proposed method, the NIC may only need to parse ULP headers and identify the subset where zero copy operation is desired e.g. a write command carrying some data with it. Most ULP of interest have headers organized according to type, length, and/or value (TLV) simplifying the NIC processing burden. In other cases, e.g. CIFS, the header format may be known to the NIC along with the locations of key fields such that using the byte count the NIC can tell when the current message ends and the next message begins. By using the TID+PID+UID+MID or a subset, a reference number may be created which may be used in allocating a buffer for a particular process or thread and employing the policies in case the buffer per entity should be limited by size, rate of allocation etc. As the number of such ULP applications that may be moving significant amounts of data may be small, e.g. CIFS and NFS, the complexity and cost of storing the instructions for parsing headers for such protocols ULP may be contained. It is also imperative to notice that the NIC may not need to keep a complete state for a given ULP or protocol. The ability to parse the headers, delineate the data and determine a command to be performed may not be dependent upon other state information may be used to take action as described in here.

In various embodiments of the invention, the policies may enable the network interface controller, within a computer system, to allocate ULP memory resources in the host for received messages, and to send a signal, for example an interrupt message, to the host processor within the computer system when the quantity of allocated memory resources, reaches a determined level. At that point, the network interface controller may use temporary buffering on the host memory and later transfer data contained within those temporary buffers to ULP allocated memory resources after such buffers are allocated. In some conventional I&P systems, the network interface controller processor may interrupt the host processor for each message received via the network. Consequently, even receipt of a message comprising a small amount of data may result in an ISR level interrupt to the host processor. In various embodiments of the invention, the network interface controller may implement policies to selectively allocate memory resources to store messages received via the network, and send a signal to the host processor when the total amount of messages reaches a determined level.

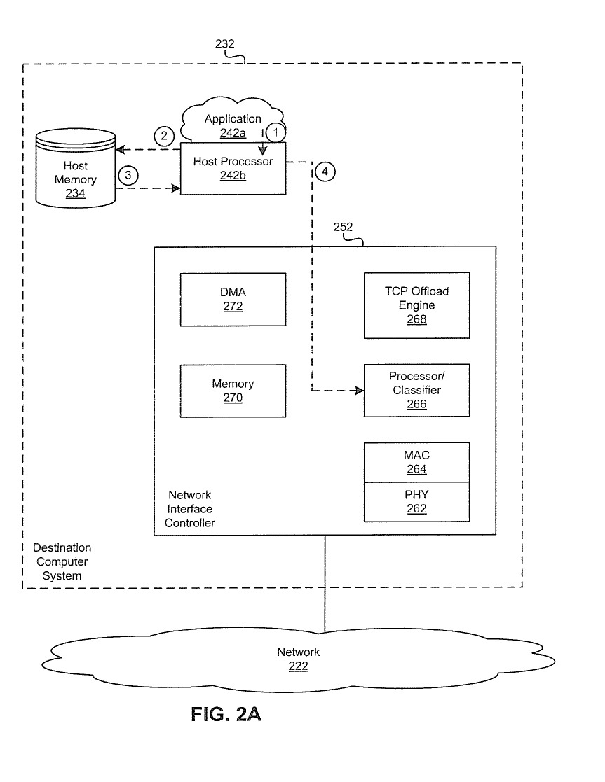

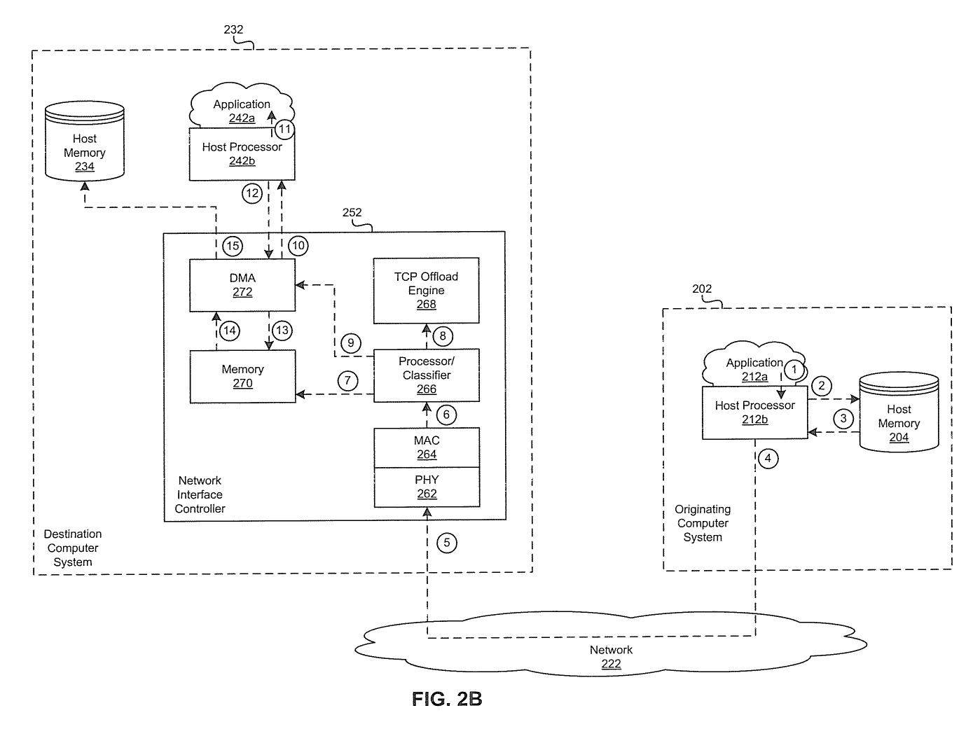

FIG. 2A illustrates exemplary configuration of a network interface controller for indicate and post processing in a flow through data architecture, in accordance with an embodiment of the invention. Referring to FIG. 2A, there is shown a destination computer system 232 or a server, and a network 222. The destination computer system 232 may comprise a host processor 242b, host memory 234, and a network interface controller 252. The host processor 242b may execute code associated with an application 242a. The network interface controller 252 may comprise a physical layer (PHY) block 262, a medium access control layer (MAC) block 264, a processor 266, a TCP offload engine (TOE) 268, memory 270, and a direct memory access block 272 as well as a unit to process or partially process ULP messages and headers and a location to store policies and host buffer pointers or at least a means to point to the location e.g. in host memory, local memory, NVRAM where that information is stored.

The destination computer system 232 may comprise suitable logic, circuitry, and/or code to enable execution of store and execute code, and to receive messages, comprising instructions and/or data, via a network to which the destination computer system 232 may be communicatively coupled. The destination computer system 232 may also transmit messages via the network to various systems that may be communicatively coupled to the network, or that may be within the network.

The host processor 242b may comprise suitable logic, circuitry, and/or code that may interpret and/or execute instructions. The instructions may be in the form of binary code. The host processor 242b may be, for example, a reduced instruction set computer (RISC) processor, a microprocessor without interlocked pipeline stages (MIPS) processor, a central processing unit (CPU), an ARM processor, a digital signal processor (DSP), an application specific integrated circuit (ASIC), microprocessor, a microcontroller, or other type of processor.

The application 242a may comprise code that may be executed to perform one or more functions, for example a file server application 110b. The application 242a may comprise code that enables processing of data and/or instructions. The code may comprise software, and/or firmware. The application 242a may comprise code that enables the transmission of messages comprising instructions and/or data. The application 242a may also comprise code that enables the reception of messages comprising instructions and/or data. The application 242a may utilize the services of operating system software and/or firmware. The application 242a may also utilize the services of other software, for example, the application 242a may utilize software that implements a communications protocol stack, such as TCP, when transmitting and/or receiving messages.

The host memory 234 may comprise suitable logic, circuitry, and/or code that may comprise storage devices that retain binary information for an interval of time. The stored binary information may be assigned physical resources within the host memory 234 for the storage. The stored binary information may be subsequently available for retrieval. Retrieved binary information may be output by the host memory 234 and communicated to other devices, components, and/or subsystems that may be communicatively coupled, directly and/or indirectly, to the host memory 234. The host memory 234 may enable the stored binary information to remain stored and/or available for subsequent retrieval until the resources allocated for the storage are de-allocated. Physical resources may be de-allocated based on a received instruction that the stored binary information be erased from the host memory 234, or based on a received instruction that the physical resources be allocated for the storage of subsequent binary information. The host memory 234 may utilize a plurality of storage medium technologies such as volatile memory, for example random access memory (RAM), and/or nonvolatile memory, for example electrically erasable programmable read only memory (EEPROM). The host memory 234 may also utilize disk storage, for example magnetic and/or optical disk storage.

The network interface controller 252 may comprise suitable circuitry, logic and/or code that may transmit and/or receive data from a network, for example, an Ethernet network. The network interface controller 252 may be communicatively coupled to the network 222, to the host processor 242b, and/or to the host memory 234. The NIC may be coupled to the host bus, integrated in a chipset or coupled to the host processor. An exemplary network interface controller 252 may comprise a network interface chip. The network interface controller 252 may perform functions, for example physical (PHY) layer, and/or medium access control layer (MAC) functions. The PHY layer functions may comprise encoding and transmission of signals via a physical medium, for example an optical fiber, or coaxial cable. The signals may comprise electrical and/or optical signal energy levels. The encoding may comprise generating corresponding electrical and/or optical signal levels corresponding to binary data. The PHY layer functions may also comprise reception and decoding of signals received via a physical medium. The MAC layer functions may comprise controlling access to the physical medium, for example detecting collisions in an Ethernet network, or detecting tokens in a token ring network. The PHY layer and/or MAC layer functions may be performed within the network interface controller 252 as specified by a specification and/or standards document such as specified in IEEE 802 standards and specification documents. The network interface controller 252 may also perform offload functions. Offload functions may be associated with higher protocol layer functions than the PHY or MAC layer, for example, and may comprise performing functions associated with network layer protocols and/or transport layer protocols, for example IP and TCP.

The PHY block 262 may comprise suitable logic, circuitry, and/or code that may enable the PHY layer functions within the network interface controller 252. The PHY layer functions may enable transmission of data frames via a communication medium. The PHY layer functions may also enable reception of data frames via the communication medium. The PHY layer functions may comprise a physical layer convergence protocol (PLCP) sublayer, which may define synchronization codes for transmission of signals, specification of markers to define the beginning and ending of a transmitted data frame, a data rate for the transmission of the data frame, and a forward error correction (FEC) code that may be utilized for detecting and/or correcting bit errors that may occur during transmission of the data frame. For received signals, the PLCP sublayer may detect markers indicating the beginning and ending of a received data frame, and may utilize a received FEC to detect and/or correct bit errors in the received data frame.

The PHY layer functions may also comprise a physical medium dependent (PMD) sublayer, which may transmit signals corresponding to PLCP sublayer specifications. The transmitted signal may comprise a data frame. The PMD sublayer may generate signals for transmission that are suitable for the physical medium being utilized for transmitting the signals. For example, for an optical communication medium, the PMD may generate optical signals, such as light pulses, or for a wired communication medium, the PMD may generate electromagnetic signals. The PMD may determine the signal energy levels for transmitted signals, the frequency of transmitted signals, the duration of signal pulses, and the modulation type utilized for transmitting modulated signals. For received signals, the PMD may detect synchronization codes indicating the presence of a signal to be received. The PMD may also detect signal levels for received signals. The PMD sublayer may also utilize a modulation type for demodulating received signals.

The MAC block 264 may comprise suitable logic, circuitry, and/or code that may enable the MAC layer functions within the network interface controller 252. The MAC layer functions may enable orderly communication between systems that are communicatively coupled via a shared communication medium. The MAC layer may comprise one or more coordination functions (CF) that enable a system to determine when it may attempt to access the shared communication medium. For example, in a wired communication medium, for example Ethernet, a CF may utilize a carrier sense multiple access with collision detection (CSMA/CD) algorithm. The MAC layer functions may implement mechanisms for scanning the communication medium to determine when it is available for transmission of signals. The MAC layer functions may comprise back off timer mechanisms, which may be utilized by a system to determine how often to attempt to access a communication medium, which is currently determined to be unavailable.

The processor 266 may comprise suitable logic, circuitry, and/or code that may interpret and/or execute instructions substantially similar to the host processor 242b. The memory 270 may comprise suitable logic, circuitry, and/or code substantially similar to the host memory 234.

The TOE 268 may comprise suitable logic, circuitry, and/or code that may enable network layer protocol and/or transport layer processing within the network interface controller 252. Network layer protocol and/or transport layer protocol processing may not be limited to TCP and/or IP, but may comprise other protocols, such as remote direct memory access (RDMA) and/or iSCSI and/or CIFS and/or NFS. TCP and/or IP processing may be performed as specified in relevant standards and/or specification documents from the Internet Engineering Task Force (IETF). RDMA processing may be performed as specified in relevant standards and/or specification documents from the IETF and/or RDMA Consortium.

The DMA block 272 may comprise suitable logic, circuitry, and/or code that may enable transfer of a block of binary information from originating locations within a first memory to destination locations a second memory, substantially without intervention and/or assistance from a host processor. The originating locations and destination locations may refer to a range of memory addresses within the first memory and second memory, respectively.

In operation in an exemplary embodiment of the invention, code related to the application 242a may be executed by the host processor 242b within the destination computer system 232 as illustrated by the reference label 1 in FIG. 2A. At least a portion of the code may cause the host processor 242b to request data from the host memory 234 as illustrated by the reference label 2. The requested data may comprise policies that may enable the network interface controller to pre-screen messages received via the network 222.

In response to the request from the host processor 242b, the host memory 234 may communicate the policy data to the host processor 242b as illustrated by the reference label 3. The host processor 242b may subsequently communicate the policy data and the buffer information to the processor 266 within the network interface controller 252 as illustrated by the reference label 4. At least a portion of the policy data may be stored as policy state information within the processor 266 and/or memory 270. The policy state information and the buffer information may enable the processor 266 to allocate resources within the memory 234 for storing messages via the network 222. The policy state information may also enable the processor 266 to classify messages received via the network 222.

Based on the classification, the processor 266 may allocate resources within the memory 234 for storage of the message. The processor 266 may, for example, classify the received message based on the connection identifier associated with the message and/or based on a message request type, for example a CIFS or NFS. The processor 266 may, for example, classify the received message based on a process identifier, which may identify an application that enabled transmission of the message via the network 222. The processor 266 may utilize the policy state information to determine when to send a signal to the host processor 242b to interrupt the host processor and/or ULP.

FIG. 2B illustrates an exemplary message exchange in a system for indicate and post processing in a flow through data architecture, in accordance with an embodiment of the invention. Referring to FIG. 2B, there is shown an originating computer system 202, a destination computer system 232, and a network 222. The originating computer system 202 may comprise a host processor 212b, and host memory 204. The destination computer system 232 may comprise a host processor 242b, host memory 234, and a network interface controller 252. The host processor 242b may execute code associated with an application 242a. The network interface controller 252 may comprise a physical layer (PHY) block 262, a medium access control layer (MAC) block 264, a processor 266, a TCP offload engine (TOE) 268, memory 270, and a direct memory access block 272.

The originating computer system 202 may be substantially similar to the destination computer system 232. The host processor 212 may be substantially similar to the host processor 242b. The host memory 204 may be substantially similar to the host memory 234.

In operation, in an exemplary embodiment of the invention, the originating computer system 202 may send one or more messages to the destination computer system 232 via the network 222. The one or more messages may be associated with a request from the application 212a, executing within the originating computer system 202, to store data within the host memory 234 within the destination computer system 232. The network interface controller 252 within the destination computer system 232 may pre-screen the received messages based on policies as specified in stored policy state information.

Code related to the application 212a may be executed by the host processor 212b within the originating computer system 202 as illustrated by the reference label 1 in FIG. 2B. At least a portion of the code may cause transmission of a message from the originating computer system 202 to the destination computer system 232. The host processor 212b may send a request to the host memory 204 for retrieval of the data to be transmitted as illustrated by the reference label 2. In response to the request from the host processor 212b, the host memory 204 may communicate the data to the host processor 212b as illustrated by the reference label 3. The host processor 212b may subsequently enable generation of a message comprising the data, and transmission of signals, comprising the message, to the network 222 as illustrated by the reference label 4.

The originating computer system 202 may utilize a transport layer protocol connection, for example a TCP connection, which may be associated with a connection identifier, when sending the message to the destination computer system 232. The originating computer system 202 may also utilize a network layer protocol, for example IP, which may be utilized by the network 222 to deliver the message to the destination computer system 232.

Signals comprising the message transmitted by the originating computer system 202 via the network 222 may be received by the PHY block 262 within the network interface controller 252 within the destination computer system 232 as illustrated by the reference label 5. After PHY layer processing, the received message may be communicated to the MAC block 264. After MAC layer processing, the received message may be communicated to the processor 266. The processor 266 may utilize policy state information to pre-screen the received message. The received message may be classified based on type length and/or value information contained within the received message or other information as indicated above. The processor 266 may, for example, classify the received message based on information such as a connection identifier associated with the received message, a socket associated with the received message, and/or a request type associated with the received message. The processor 266 may, for example, classify the received message based on a process identifier, which may identify the application 212a within the originating computer system 202 that enabled transmission of the message via the network 222. Based on the classification, the processor 266, for example, may allocate resources within the memory 234 for storage of the received message as illustrated by the reference label 7. The processor 266 may update the policy state information based on the quantity of resources within the memory 234 allocated for storage of the received message. The updated policy state information may also indicate a remaining quantity of resources that are available within the memory 234 for storage of subsequent messages, for example.

The processor 266 may also communicate information related to the received message to the TOE 268 as illustrated by the reference label 8. The TOE 268 may utilize the information to modify connection state information associated with, for example, a TCP connection utilized for communicating the received message from the originating computer system 202 to the destination computer system 232. The TOE 268 may, for example, update a packet counter value, and/or packet window size value based on the received information.

The TOE may communicate information to the processor 266 to indicate whether the received message or a portion of it was received out-of-order (OOO) in a sequence of messages transmitted by the originating computer system 202. If the TOE 268 determines that the received message is not OOO, the processor 266 may be instructed to process the message as described above including providing the host ULP with an indicate flag associated with the message. If the TOE 268 determines that the received message is OOO, the processor 266 may be instructed to not indicate the message or portion thereof until subsequent messages are received such that the current received message or the header portion of it is no longer OOO. In some cases a segment received OOO will prevent the NIC from being able to parse or delineate incoming messages for header and data fields. If the received message is out of order and the NIC cannot keep state for the received segment until the hole in the message sequence created by the OOO segment has been filled by the receipt of intervening message segments, the TOE 268 may instruct the processor 266 to discard the received message.

The TOE 268 may also modify the connection state information to enable an acknowledgement of receipt of the message to subsequently be communicated from the destination computer system 232 to the originating computer system 202. The acknowledgement may enable the originating computer system 202 to determine that the transmitted message was successfully received at the destination computer system 232.

Based on the policy state information, for example the quantity or remaining available resources in the memory 234, the processor may subsequently cause a signal to be communicated to the host processor 242b in advance of a transfer of stored received messages from the memory 234 within the network interface controller 252 to the host memory 234. In various embodiments of the invention, this may occur after receipt of a plurality of messages via the network 222, such as illustrated by the reference label 5.

In response to the indicate signal, the host processor 242b may communicate a notification for the received messages to the application 242a as illustrated by the reference label 11. The host processor 242b may communicate a response to the DMA block 272 as illustrated by the reference label 12. The response may indicate acceptance of the transfer request as illustrated by the reference label 10. The DMA block 272 may initiate the transfer by communicating one or more instructions to the memory 270 requesting retrieval of at least a portion of the stored received messages as illustrated by the reference label 13. The instructions may indicate physical and/or logical address locations where the requested messages are stored within the memory 270. The memory 270 may respond to the instructions by outputting the requested messages as illustrated by the reference label 14. The DMA block 272 may transfer the messages retrieved from the memory 270 to the host memory 234 by communicating one or more instructions to the host memory 234 requesting that the messages retrieved from the memory 270 be stored within the host memory 234 as illustrated by the reference label 15.

In various embodiments of the invention, a network interface controller 252 may pre-screen messages received via the network 222 based on policy state information that was configured by a host processor 242b. The policy state information may enable the network interface controller 252 to allocate resources for storage of received messages via the network 222 within the host memory 234. The network interface controller may perform the pre-screening without interrupting the host processor 242b. The network interface controller 252 may utilize the policy state information to determine when to send a signal to the host processor 242b to initiate transfer of stored messages from the wire directly to the host memory 234.

In this regard, the network interface controller 252 may enable more efficient data transfer performance at a destination computer system 232 by storing a plurality of small messages, and subsequently sending a signal to the host processor 242b once to transfer the block of stored messages, rather than interrupting the host processor 242b upon receipt of each individual message.

In various embodiments of the invention, the network interface controller 252 may enable the host processor 242b to receive a signal upon receipt of a single stored message based on the policies represented within the policy state information. For example, a policy may determine that an originating computer system is a trusted system, and/or a system, which routinely transfers large quantities of messages within each transaction. Alternatively, the network interface controller 252 may deny allocation of resources within the memory 234 for storage of received messages based on the policies represented within the policy state information, for example, for an originating computer system which has already transferred a given quantity of data, and is not trusted to transfer any more data within a given time duration. When the network interface controller 252 denies allocation of resources for a received message, connection state information, stored in connection with a TOE 268 and associated with a connection utilized for receipt of the message via the network 222, may be updated accordingly to indicate that the received message was rejected, or dropped, or simply placed in a temporary buffer rather than in a ULP allocated buffer at the destination computer system 232.

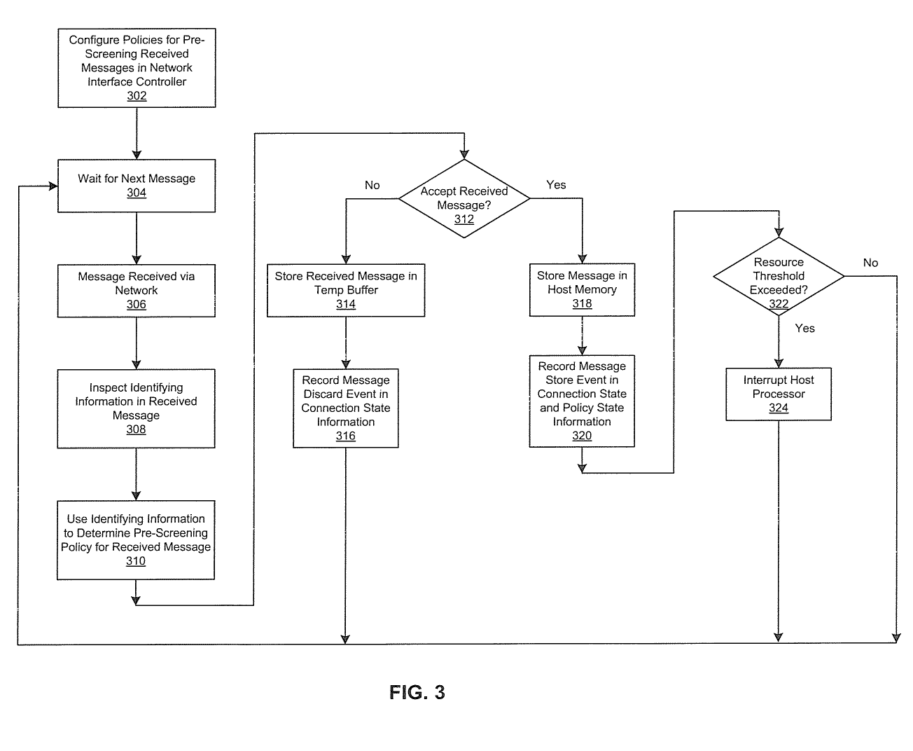

FIG. 3 is a flowchart illustrating exemplary steps for indicate and post processing in a flow through data architecture, in accordance with an embodiment of the invention. Referring to FIG. 3, in step 302 a processor 266 in a network interface controller 252 may be configured to utilize policies for pre-screening received messages and storing of a buffer list. The host may add buffers to the list from time to time. In step 304, the network interface controller 252 may wait to receive a next message via a network 222. In step 306, a message may be received via the network 222. In step 308, the processor 266 may inspect identifying information contained within the received message. In step 310, the processor 266 may utilize the identifying information to determine a pre-screening policy for the received message. In step 312, the processor 266 may determine whether to place the data in the received message in a ULP allocated buffer.

If the processor 266 determines that the received message is not to be stored in a ULP allocated buffer in step 312, e.g. due to a policy due to or lack of activity on the connection etc., in step 314, the received message may be placed in a temporary buffer. In step 316, connection state information may be updated in response to the message discard event. The connection state information may be associated with a connection utilized when receiving the message at the network interface controller 252. The TOE 268 may be utilized for updating the connection state information. Step 304 may follow step 316.

If the processor 266 determines that the received message is to be placed in a ULP buffer it may allocate a buffer in step 312, in step 318, the received message may be placed and stored in ULP provided host memory 234. In step 320, connection state information, and policy state information may be updated in response to the message store event. The connection state information may be updated in response to acceptance of the received message. The updated policy state information may indicate the quantity of memory resources utilized for storing the received message, a connection identifier associated with the received message, and/or a quantity of memory resources available for storage of subsequent received messages, for example. The processor may notify or indicate to the ULP that the header has been received, and provide the header content to it. This allows the ULP to maintain ULP state information.

In step 322, the processor 266 may determine whether a resource threshold has been exceeded. A resource threshold, for example, may reflect that a quantity of memory resources available, as measured in bytes for example, is below a threshold value. If the processor 322 determines that the resource threshold has not been exceeded in step 322, step 304 may follow step 322.

If the processor 322 determines that the resource threshold has been exceeded in step 322, in step 324, the processor 266 may cause a signal, for example an interrupt message, to be communicated to the host processor 242b. The signal may comprise a request that one or more messages, stored within the memory 234, be transferred and stored within the host memory 234, for example. Step 304 may follow step 324.

Various embodiments of the invention may not be limited to configurations in which the host memory 234 is physically contained within the destination computer system 232, as the invention may also be practiced in configurations in which at least a portion of the host memory 234 is physically external to the destination computer system 232. The host memory 234 may utilize storage area network (SAN), and/or network attached storage (NAS) technologies.

Various embodiments of the invention may not be limited to TCP, as the invention may also be practiced in connection with other transport layer protocols such as sequenced packet exchange (SPX), user datagram protocol (UDP), transport layer security (TLS), secure socket layer (SSL), internet small computer system interface (iSCSI), stream control transmission protocol (SCTP), AppleTalk transaction protocol (ATP), and the IL protocol (IL).

Various embodiments of the invention may also not be limited to IP, comprising IPv4 and IPv6 and related protocols such as the internet group multicast protocol (IGMP), as the invention may also be practiced in connection with other network layer protocols such as internetwork packet exchange (IPX), X.25 packet level protocol, internet protocol security (IPSec), and datagram delivery protocol (DDP).

Various embodiments of the invention may not be limited to Ethernet, as the invention may be practiced in connection with a plurality of protocols for local area networks (LAN), metropolitan area networks (MAN), and/or wide area networks (WAN) such as multiprotocol label switching (MPLS), frame relay, asynchronous transfer mode (ATM), token ring, fiber distributed data interface (FDDI), StarLAN, point to point protocol (PPP), economy network (Econet), and attached resource computer network (ARCnet), in addition to LAN protocols defined by IEEE 802.2, and IEEE 802.3.

Aspects of a system for indicate and post processing in a flow through data architecture may include a network interface controller 252 that enables storage of at least a portion of a plurality of received messages based on policies that may be enforced by the network interface controller. The network interface controller 252 may enable generation of a signal to a host processor 242b that processes some of the stored plurality of received messages based on the policies that may be enforced by the network interface controller 252. The host processor 242b may enable configuration of the policies to the network interface controller 252.

A processor 266 within the network interface subsystem 252 may enable generation of policy state information based on the configured policies. The policy state information may enable monitoring of resource utilization for storage of received messages within memory 270 according to a connection identifier, for example. The policy state information may comprise stored information, for example in memory 270. The policies may comprise a connection identifier, a process identifier, a quantity of allocated storage resources for at least a portion of the plurality of received messages, a quantity of available storage resources, which may be utilized for storage of received messages within memory 270 for example, and/or at least one request type. The processor 266 may enable inspection of each of the plurality of received messages based on the policies.

The processor 266 may enable determination of where to place each of the plurality of received messages and whether to accept or reject each of the plurality of received messages based on policy state information. The TOE 268 may enable modification of connection state information based on whether any one of the plurality of received messages is accepted or rejected. The processor 266 may enable modification of the policy state information when any one of the plurality of received messages is accepted. The processor 266 may enable storage of an accepted one of the plurality of received messages in host memory 234 based on the policy state information. The processor 266 may enable retrieval of at least some of the stored plurality of received messages from the memory 270 located within the network interface controller 252 and subsequent storage of the retrieved messages in host memory 234.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing received data in a communication system, the method comprising:
storing at least a portion of a plurality of received messages based on policies that are enforced by a network interface controller; and
generating a signal to a host processor that processes some of said at least a portion of said stored plurality of received messages based on said policies.

2. The method according to claim 1, comprising configuring said policies in said network interface controller.

3. The method according to claim 2, comprising generating policy state information based on said configured polices.

4. The method according to claim 2, wherein said policies comprise at least one of: a connection identifier, a process identifier, a quantity of allocated storage resources for at least a portion of said plurality of received messages, a quantity of available storage resources, and at least one request type.

5. The method according to claim 2, comprising inspecting each of said plurality of received messages based on said policies.

6. The method according to claim 1, comprising determining one of: accepting and rejecting, each of said plurality of received messages based on policy state information.

7. The method according to claim 6, comprising modifying connection state information based on said one of: said accepting and said rejecting, one of said plurality of received messages.

8. The method according to claim 6, comprising modifying said policy state information based on said accepting one of said plurality of received messages.

9. The method according to claim 6, comprising storing said accepted said each of said plurality of received messages, in memory located within host memory, based on said policy state information.

10. The method according to claim 1, comprising retrieving said some of said at least a portion of said stored plurality of received messages from memory located within said network interface controller and storing said retrieved said some of said at least a portion of said stored plurality of received messages in host memory.

11. The method according to claim 1, comprising determining a location at which to store said at least a portion of said plurality of received messages based on at least one buffer pointer and corresponding length

12. The method according to claim 1, comprising performing upper layer protocol processing within said network interface controller to enable said storing.

13. A system for processing received data in a communication system, the system comprising:
circuitry that enables storage of at least a portion of a plurality of received messages based on policies that are enforced by a network interface controller; and
said circuitry enables generation of a signal to a host processor that processes some of said at least a portion of said stored plurality of received messages based on said policies.

14. The system according to claim 13, wherein said circuitry enables configuration of said policies in said network interface controller.

15. The system according to claim 14, wherein circuitry enables generation of policy state information based on said configured polices.

16. The system according to claim 14, wherein said policies comprise at least one of: a connection identifier, a process identifier, a quantity of allocated storage resources for at least a portion of said plurality of received messages, a quantity of available storage resources, and at least one request type.

17. The system according to claim 14, wherein said circuitry enables inspection of each of said plurality of received messages based on said policies.

18. The system according to claim 13, wherein said circuitry enables determination of one of: accepting and rejecting, each of said plurality of received messages based on policy state information.

19. The system according to claim 18, wherein said circuitry enables modification of connection state information based on said one of: said accepting and said rejecting, one of said plurality of received messages.

20. The system according to claim 18, wherein said circuitry enables modification of said policy state information based on said accepting one of said plurality of received messages.

21. The system according to claim 18, wherein said circuitry enables storage of said accepted said each of said plurality of received messages, in memory located within host memory, based on said policy state information.

22. The system according to claim 13, wherein said circuitry enables retrieval of some of said at least a portion of said stored plurality of received messages from memory located within said network interface controller and storage of said retrieved said some of said at least a portion of said stored plurality of received messages in host memory.

23. The system according to claim 13, wherein said circuitry enables determination of a location at which to store said at least a portion of said plurality of received messages based on at least one buffer pointer and corresponding length

24. The system according to claim 13, wherein said circuitry enables performing upper layer protocol processing within said network interface controller to enable said storage.
